(19) United States
(12) Patent Application Publication
(10) Pub. No.: US 2023/0347333 A1
(43) Pub. Date: Nov. 2, 2023

(54) Membranes

(71) Applicants: FUJIFILM MANUFACTURING EUROPE BV, Tilburg (NL); Fujifilm Corporation, Tokyo (JP)

(72) Inventors: Renée Maria Ripken, Tilburg (NL); Takeshi Narita, Tilburg (NL); Maarten Constant Gerlach Marie Meijlink, Tilburg (NL); Elisa Huerta Martinez, Tilburg (NL); Jacko Hessing, Tilburg (NL)

(21) Appl. No.: 18/041,846

(22) PCT Filed: Sep. 27, 2021
(86) PCT No.: PCT/EP2021/076437

§ 371 Date: Feb. 16, 2023

(30) Foreign Application Priority Data
Sep. 29, 2020 (GB) 2015379.7

(51) Int. Cl. B01J 47/12; C08J 5/22; B01J 43/00; B01D 61/44; B01D 69/12; B01D 67/00; B01D 69/10; B01D 71/66; B01D 69/02

(52) U.S. Cl. CPC B01J 47/12; C08J 5/2231; B01J 43/00; B01D 61/445; B01D 69/1216; B01D 69/1213; B01D 67/0013; B01D 69/107; B01D 71/69; B01D 69/02; C08J 2325/18; B01D 2323/46; B01D 2325/18; B01D 2325/42

(57) ABSTRACT

A membrane comprising: a) a first layer comprising a first polymer or a fourth polymer having ionic groups of polarity opposite to the polarity of the ionic groups of the third polymer; b) a second layer comprising a second polymer having ionic groups of polarity the same as the polarity of the ionic groups of the third polymer; and c) a third layer comprising a co-continuous polymeric network of (i) a third polymer having ionic groups and a network of pores; and (ii) a fourth polymer having ionic groups of polarity opposite to the polarity of the ionic groups of the third polymer; wherein layer c) is interposed between layer a) and layer b) and the third polymer is obtainable by a process comprising phase separation of the third polymer from a curable composition used to prepare the third polymer.

This invention relates to membranes, their preparation processes and their use. Ion exchange membranes are used in electrodialysis, reverse electrodialysis, electrolysis, diffusion dialysis and a number of other processes. Typically the transport of ions through the membranes occurs under the influence of a driving force such as an ion concentration gradient or, alternatively, an electrical potential gradient.

Ion exchange membranes are generally categorized as cation exchange membranes or anion exchange membranes, depending on their predominant charge. Cation exchange membranes comprise negatively charged groups that allow the passage of cations but reject anions, while anion exchange membranes comprise positively charged groups that allow the passage of anions but reject cations. A bipolar membrane has both a cationic layer and an anionic layer.

Some ion exchange membranes and bipolar membranes comprise a porous support, which provides mechanical strength. Such membranes are often called “composite membranes” due to the presence of both an ionically-charged polymer which discriminates between oppositely charged ions and the porous support which provides mechanical strength.

Composite membranes are known from, for example, U.S. Pat. No. 4,253,900, which describes a bipolar membrane containing a monobead layer of ion exchange resin. WO2017/205458 and the article by McClure in ECS Transactions, 2015 69 (18) pages 35-44 describe a bipolar membrane containing a junction layer of interpenetrating polymer nanofibers or microfibers of anion exchange polymers and cation exchange polymers. Other examples of composite membranes are described in e.g. EP3604404, wherein one of the layers comprise an ion exchange resin powder, and U.S. Pat. No. 4,673,454 disclosing the use of an ion exchange resin in an interfacial layer. There is a desire to provide membranes having improved properties, e.g. high permselectivity, low electrical resistance, good mechanical strength, low swelling under aqueous conditions, stability at extremes of pH. Ideally such membranes may be produced quickly, efficiently and cheaply.

According to a first aspect of the present invention there is provided a membrane comprising:
a) a first layer comprising a first polymer or a fourth polymer having ionic groups of polarity opposite to the polarity of the ionic groups of the third polymer;
b) a second layer comprising a second polymer having ionic groups of the same polarity as the polarity of the ionic groups of the third polymer; and
c) a third layer comprising a co-continuous polymeric network of (i) a third polymer having ionic groups and a network of pores; and (ii) a fourth polymer having ionic groups of polarity opposite to the polarity of the ionic groups of the third polymer;
wherein layer c) is interposed between layer a) and layer b) and the third polymer is obtainable by a process comprising phase separation of the third polymer from a curable composition used to prepare the third polymer.

In this document (including its claims), the verb “comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually mean “at least one”. Also in this specification the first polymer having ionic groups of polarity opposite to the polarity of the ionic groups of the third polymer is sometimes abbreviated to “the first polymer”, the second polymer having ionic groups of the same polarity as the polarity of the ionic groups of the third polymer is sometimes abbreviated to “the second polymer”, the third polymer having ionic groups of polarity opposite to the polarity of the ionic groups of the first polymer is sometimes abbreviated to “the third polymer” and the fourth polymer having ionic groups of polarity opposite to the polarity of the ionic groups of the third polymer is sometimes abbreviated to “the fourth polymer”.

In order to achieve the two opposite polarities required for the third polymer and the fourth polymer, one of the third and fourth polymers is a cationic polymer (i.e. carries positively charged groups) and the other is an anionic polymer (i.e. carries negatively charged groups).

In order to achieve the two opposite polarities required for the third polymer and the first polymer, one of the third and first polymers is a cationic polymer (i.e. carries positively charged groups) and the other is an anionic polymer (i.e. carries negatively charged groups).

In a preferred embodiment the third polymer is obtainable by phase-separation of the third polymer from a composition used to prepare the third polymer. In this way one may obtain the third polymer in a form which comprises a network of pores and the pores may be used to receive the fourth polymer (or a curable composition used to prepare the fourth polymer) in order to make the third layer c) and provide a co-continuous polymeric network of (i) the third polymer having ionic groups; and (ii) the fourth polymer having ionic groups of polarity opposite to the polarity of the ionic groups of the third polymer and being present within the network of pores of the third polymer.

In one embodiment the curable composition used to prepare the fourth polymer is identical to the curable composition used to prepare the first polymer. In this way one may obtain a membrane in which the first polymer is identical to the fourth polymer. Preferably the co-continuous polymeric network comprises the third polymer and the fourth polymer, wherein the third polymer provides a network of pores and the fourth polymer is present within that network of pores.

Preferably the third polymer comprises a porous first polymeric domain comprising ionic groups and a network of pores. Preferably the fourth polymer comprises a second polymeric domain comprising ionic groups having a charge opposite to the charge of the ionic groups of the first polymeric domain. In this embodiment the second polymeric domain is located in the pores of the first polymeric domain (i.e. in the network of pores of the third polymer).

The co-continuous polymeric network preferably comprises two individual, continuous, polymeric domains, one bearing anionic charges and the other bearing cationic charges. Preferably one of the polymeric domains is phase-separated, e.g. one of the third and fourth polymers, especially the third polymer, is obtained by phase separation from a composition used to prepare that polymer in porous form and the other polymer, i.e. the fourth polymer, fills the pores of that polymer. Preferably the third and fourth polymers in the third layer (c) are non-mixed, non-encapsulated and preferably they are non-fibrillar. Optionally the third layer contains one or more than one further polymeric domains each bearing an anionic charge or a cationic charge.

In a preferred embodiment the fourth polymer is present in the network of pores of the third polymer and in the first layer a). In another preferred embodiment, the third polymer has the same charge as and/or is chemically identical to the second polymer in the second layer b).

In a preferred embodiment the chemical composition of the first polymer is the same as or substantially the same as the chemical composition of the fourth polymer.

In another preferred embodiment the chemical composition of the second polymer is the same as or substantially the same as the chemical composition of the third polymer.

The third layer c) preferably comprises at least two continuous intermingled polymeric domains (one domain derived from the third polymer and the other domain derived from the fourth polymer) having a large contact area with each other. This may be achieved by the third polymer comprising a network of pores and the fourth polymer being different to the third polymer (e.g. one is cationic and the other is anionic) and being present within the network of pores of the third polymer. As a result of this large contact area between the two (or more) polymers present in the third layer and, when the membrane is used as a bipolar membrane, the amount of water molecules that is dissociated into H⁺ and OH⁻ per unit of time is increased and thereby the productivity of the bipolar membrane is also increased.

The large contact area between the third and fourth polymers present in the third layer is preferably provided by the co-continuous network wherein the two (or more) polymeric domains derived from the third and fourth polymers bear opposite charges (i.e. one domain has anionic charges and the other has cationic charges). An advantage of the co-continuous network is that newly produced anions (e.g. OH⁻) and cations (e.g. H⁺) created at the interface between the third and fourth polymers (i.e. the interface of the two polymeric domains) are separated into the individual polymeric domains immediately after their formation, preventing ion recombination. In addition, the adhesion between the third and fourth polymers (i.e. adhesion between the first and second polymeric domains) in the third layer c) is extremely strong as a result of the entanglement of the third and fourth polymers, and the large contact area between the third and fourth polymers. The strong adhesion between the third and fourth polymers prevents/reduces the so-called ballooning effect in which large water-filled blisters can be formed at the interface between positively and the negatively charged polymers of a bipolar membrane, where OH⁻ and H⁺ might recombine (undesirably) to form water.

The membrane of the present invention preferably comprises an interface between the first layer a) and the third layer c) (a first interface) and an interface between the third layer c) and the second layer b) (a second interface) and preferably both the first interface and the second interface are uninterrupted, without any gaps and/or spaces between the first layer a) and the third layer c) and without any gaps and/or spaces between the third layer c) and the second layer b).

In one embodiment the third layer c) comprises a blend morphology of two continuous polymeric domains derived from the third and fourth polymers respectively, of which one domain (derived from the fourth polymer) is located within the other domain (derived from the third polymer), forming the abovementioned co-continuous polymeric network (of the fourth polymer within the network of pores of the third polymer).

Preferably each of the first and second polymeric domains is continuous, and substantially comprises a single covalently linked carbon backbone such that it is interconnected to itself.

Preferably the polymeric domains are not encapsulated, not isolated, not discontinued and are non-fibrillar (e.g. not made by electrospinning).

In the present invention the third layer c) preferably comprises a porous support and within the porous structure of this support the third polymer comprising a network of pores and the fourth polymer present within those pores (thereby providing the co-continuous polymeric network, e.g. two polymeric domains of which one bears anionic charges and the other cationic charges. The two (or more) polymeric domains (one from the third polymer and another from the fourth polymer present within the network of pores of the third polymer) occupy the pores of the porous support and preferably comprise a seamless (third) interface (the first and second interfaces being at the junction of the third layer c) and the first and second layers a) and b) respectively). Thus the membrane preferably comprises an interface at the junction of the third layer c) and the first layer a), an interface at the junction of the third layer c) and the second layer b), and a third interface within the third layer c) at the junction of the third polymer and the fourth polymer. Preferably this third interface is uninterrupted, without any gaps and/or spaces between the third polymer and the fourth polymer. Preferably this third interface is not an interface between an polymer and fused/compressed fibers, beads, or particles.

The volume fraction of the third polymer or the fourth polymer is defined as the fraction of the volume of the third polymer or the fourth polymer as part of the total volume of the third layer c) itself. The volume fraction of the third polymer in the third layer c) is preferably from 0.1 to 0.9, more preferably from 0.2 to 0.8, especially 0.3 to 0.7, e.g. about 0.4, about 0.5 or about 0.6.

In one embodiment the third polymer is obtained by a process comprising polymerisation-induced phase separation, more preferably photopolymerization-induced phase separation, e.g. of the third polymer from a composition used to prepare that polymer. This preference arises because such a process is particularly good at providing a third polymer which comprises a network of pores capable of receiving the fourth (oppositely charged) polymer or a curable composition for preparing the fourth (oppositely charged) polymer. In this process, preferably the third polymer is formed by a (photo-)polymerization reaction.

Preferably, the third polymer comprises a network of pores which has an average pore diameter of less than 5 μm, more preferably less than 2 μm, especially less than 1 μm. The pores within the third polymer may then be filled with a (fourth) curable composition and that curable composition may then be cured in order to provide the fourth polymer within the third polymer's network of pores. In a preferred embodiment the third polymer's network of pores is substantially or completely filled with the fourth polymer. As a consequence, the third layer results in which the third polymer comprises a network of pores which are filled with the (oppositely charged) fourth polymer. The third and fourth polymers may therefore provide a co-continuous polymeric network comprising two polymeric domains: one from the third polymer and another from the fourth polymer. In a preferred embodiment this co-continuous polymeric network is free from other polymers (except for any polymer present in the porous support). In one embodiment there are covalent bonds connecting the third and fourth polymers together. In fact the pores present in the third polymer may comprise more than one polymer, e.g. the fourth polymer (derived from a fourth curable composition) and optionally a second polymer (derived from a second curable composition) such that the fourth polymer partly fills the pores of the third polymer and the second polymer is filling the remaining pores. Additionally the pores in the third polymer may comprise one or more further polymers if desired.

### BRIEF DESCRIPTION OF THE DRAWINGS:

FIG. 1A shows a known membrane.

FIG. 1B shows a membrane according to the present invention.

FIG. 1A illustrates a cross-section through a typical membrane described in the prior art.

FIG. 1B illustrates a cross-section through a membrane according to the present invention.

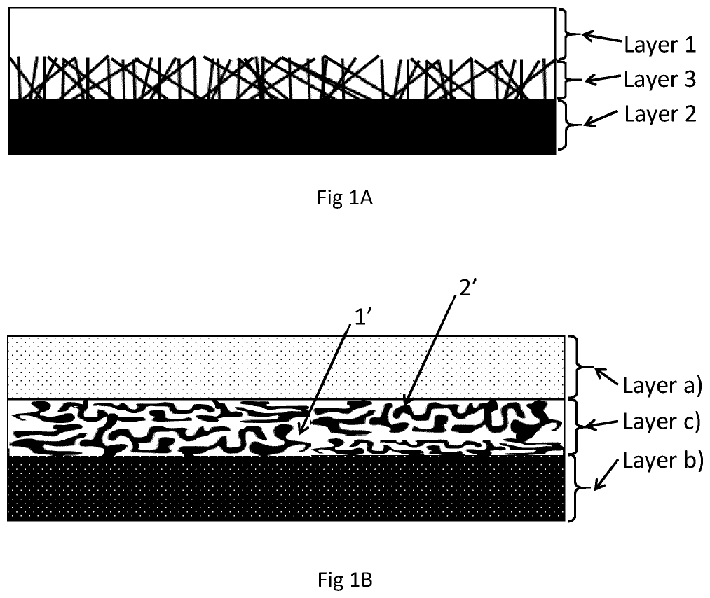

In FIG. 1A, Layer 1 is a polymer layer, Layer 3 is a centre layer comprising fibrous elements and Layer 2 is another polymer layer.

In FIG. 1B, Layer a) is the first layer a) comprising the first polymer or the fourth polymer and optionally a porous support (not shown). Layer c) is the third layer c) comprising the third (2′) and fourth (1′) polymers in black and white respectively.

The third polymer (black) is located within the pores of the porous support (not shown) and the fourth polymer (white) is within the porous network of the third polymer (black). Layer b) is the second layer b) comprising the second polymer and optionally a porous support (not shown).

When the membrane comprises more than one porous support, the porous supports may be physically and chemically identical to each other or they may be different from one or more of the other porous supports present in the membrane (if any), depending on the properties desired for and intended use of the membrane.

Preferably at least one of the layers a), b) and c) comprises a porous support. Thus the membrane of the present invention is preferably a composite membrane. A porous support is useful to provide mechanical strength and typically one or more of the layers a), b) and c) comprise a porous support. Each porous support may be positioned wholly within a layer or, if desired, at the interface of layer c) and layer a) and/or the interface of layer c) and layer b).

In one embodiment, a single porous support is present in and common to both the first layer a) and the third layer c). In this embodiment, layer b) optionally comprises a second porous support. In each case, the polymer of the relevant layer is preferably present within the pores of the relevant porous support.

In another embodiment, a single porous support is present in and common to both the second layer b) and the third layer c). In this embodiment, layer a) optionally comprises a second porous support. In each case, the polymer of the relevant layer is preferably present within the pores of the relevant porous support.

Optionally only two of layers a), b) and c) comprise a porous support. For example, layers a) and c) comprise a porous support and layer b) is free from porous supports, or layers b) and c) comprise a porous support and layer a) is free from porous supports, or layers a) and b) comprise a porous support and layer c) is free from porous supports. When only two of layers a), b) and c) comprise a porous support, the two layers optionally each comprise a separate support or the two layers comprise the same single support.

In a preferred embodiment at least layer c) comprises a porous support.

In another embodiment, layer c) is partly supported by a first porous support and partly unsupported. Preferably in this embodiment the membrane comprises a porous support which fully supports layer a) or layer b) and partly supports layer c). The remaining layer (layer b) or layer a) as the case may be) is preferably free from porous supports or comprises a second porous support.

As examples of porous supports which may be included in the layers a), b) and/or c) there may be mentioned woven and non-woven synthetic fabrics and extruded films. Examples include wetlaid and drylaid non-woven material, spunbond and meltblown fabrics and nanofiber webs made from, e.g. polyethylene, polypropylene, polyacrylonitrile, polyvinyl chloride, polyphenylenesulfide, polyester, polyamide, polyaryletherketones such as polyether ether ketone and copolymers thereof. Porous supports may also be porous membranes, e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene and polychlorotrifluoroethylene membranes and derivatives thereof.

Preferably the porous support(s), when present, each independently have an average thickness of between 10 and 400 μm, more preferably between 20 and 150 μm and especially between 30 and 100 μm.

Preferably the porous support(s), when present, have a porosity of between and 95%. The porosity of a support may be determined by a porometer, e.g. a Porolux™ 1000 from IB-FT GmbH, Germany.

One or more of the porous supports may be treated to modify its surface energy, e.g. to values above 45 mN/m, preferably above 55 mN/m. Suitable treatments include corona discharge treatment, plasma glow discharge treatment, flame treatment, ultraviolet light irradiation treatment, chemical treatment or the like, e.g. for the purpose of improving the wettability of and the adhesiveness to the porous support.

Commercially available porous supports are available from a number of sources, e.g. from Freudenberg Filtration Technologies (Novatexx materials), Lydall Performance Materials, Celgard LLC, APorous Inc., SWM (Conwed Plastics, DelStar Technologies), Teijin, Hirose, Mitsubishi Paper Mills Ltd and Sefar AG.

Preferably each porous support independently is a polymeric support. Preferred supports comprise a woven or non-woven synthetic fabric or an extruded film without covalently bound ionic groups.

Preferably the first layer a), the second layer b) and the third layer c) of the membrane each independently has an average thickness of between 10 μm and 200 μm, more preferably of between 20 μm and 150 μm and especially between 30 and 100 μm.

Preferably the membrane of the present invention has an average thickness of between 30 μm and 600 μm, more preferably of between 60 μm and 450 μm and especially between 90 and 300 μm.

Preferably the membrane of the present invention is a bipolar membrane. The first, second, third and fourth polymers are preferably each independently obtained by a process comprising curing a curable composition comprising a curable compound having an ionic group, e.g. an anionic group or a cationic group. Thus the first polymer may be obtained from a first curable composition, the second polymer may be obtained from a second curable composition, the third polymer may be obtained from a third curable composition and the fourth polymer may be obtained from a fourth curable composition.

Depending on the pH of the composition, the ionic groups may be partially or wholly in salt form. The curable compound having an ionic group may be rendered curable by the presence of one or more ethylenically unsaturated groups. Thus the curable compound having an ionic group preferably comprises an ethylenically unsaturated group and a cationic group or an anionic group. Anionic groups have a polarity opposite to cationic groups.

Preferred ethylenically unsaturated groups include vinyl groups and (meth)acrylic groups (e.g. CH₂═CR⁴C(O)— groups), especially allyl groups, aromatic vinyl groups (e.g. styrenic groups), (meth)acrylate groups (e.g. CH₂═CR⁴ C(O)O— groups) and (meth)acrylamide groups (e.g. CH₂═CR⁴ C(O)NR⁴— groups), wherein each R⁴ independently is H or CH₃.

Preferred anionic groups are acidic groups, for example a sulpho, carboxy and/or phosphato groups, especially sulpho groups. The preferred salts are lithium, ammonium, sodium and potassium salts and mixtures comprising two or more thereof.

Preferred cationic groups are quaternary ammonium groups.

Examples of curable compounds having an anionic group or a quaternary ammonium group are provided below.

The curable compositions which may be used to prepare the first, second third and fourth polymers preferably further comprise a crosslinking agent, e.g. curable compound comprising at least two ethylenically unsaturated groups and optionally an ionic group, in an amount of 1 to 88 wt % (or 1 to 70wt %). Examples of curable compound comprising at least two ethylenically unsaturated groups and optionally an ionic group are provided below.

The curable compositions which may be used to prepare the first, second third and fourth polymers preferably further comprise a radical initiator, e.g. 0 to 10 wt % of radical initiator. Examples of suitable radical initiators are provided below.

The curable compositions which may be used to prepare the first, second third and fourth polymers preferably further comprise a solvent, e.g. 0 to 55wt % or 20 to 98 wt % of solvent. Examples of suitable solvents are provided below. Preferably the first polymer is obtainable by a process comprising curing a first curable composition comprising:
(a1) 0 to 60 wt % of a curable compound having one ethylenically unsaturated group and an ionic group;
(b1) 1 to 88 wt % of a curable compound comprising at least two ethylenically unsaturated groups and optionally an ionic group;
(c1) 0 to 10 wt % of radical initiator; and
(d1) 0 to 55 wt % of solvent.

Preferably the second polymer is obtainable by a process comprising curing a second curable composition comprising:
(a2) 0 to 60 wt % of a curable compound having one ethylenically unsaturated group and an ionic group of charge opposite to the curable compound present in the first curable composition;
(b2) 1 to 88 wt % of a curable compound comprising at least two ethylenically unsaturated groups and optionally an ionic group (of charge opposite to the curable compound present in the first curable composition);
(c2) 0 to 10 wt % of radical initiator; and
(d2) 0 to 55 wt % of solvent.

As mentioned above, the third polymer is preferably obtained from a process comprising polymerisation-induced phase separation of the third polymer from a third curable composition used to prepare the third polymer. This process is particularly useful for providing the third polymer in a form which comprises a network of pores capable of receiving a fourth curable composition (which may be identical to the first curable composition or different to the first curable composition) for preparation of the fourth polymer within the network of pores (and optionally on the surface of the third polymer too, if desired, in order to provide the first layer a) in a very efficient manner). In this way one may prepare and then impregnate the network of pores present in the third polymer with a fourth curable composition suitable for forming the fourth polymer and cure the fourth curable composition within the network of pores of the third polymer and optionally on the surface of the third polymer in order to simultaneously make layer a) at the same time as making third layer c).

Preferably the third polymer comprising ionic groups and the network of pores is obtainable by a process comprising curing a third curable composition comprising:
(a3) 0 to 60 wt % of a curable compound having one ethylenically unsaturated group and an ionic group;
(b3) 1 to 70 wt % of a curable compound comprising at least two ethylenically unsaturated groups and optionally an ionic group;
(c3) 0 to 10 wt % of radical initiator; and
(d3) 20 to 98 wt % of solvent.

Preferably the polarity of the ionic group of components (a3/b3) is the same as the polarity of the ionic group of components (a2/b2) and opposite to the polarity of the ionic group of components (a1/b1).

Preferably the fourth polymer is obtainable by a process comprising curing a fourth curable composition which falls within the definition provided above for the first curable composition. The fourth curable composition may be the same as or different to the first curable composition. Preferably the fourth curable composition comprises a curable compound having one ethylenically unsaturated group and an ionic group of charge opposite to the curable compound present in the third curable composition. Thus, the fourth polymer is obtainable by a process comprising curing a fourth curable composition comprising:

(a4) 0 to 60 wt % of a curable compound having one ethylenically unsaturated group and an ionic group of charge opposite to the curable compound present in the third curable composition;

(b4) 1 to 88 wt % of a curable compound comprising at least two ethylenically unsaturated groups and optionally an ionic group (of charge opposite to the curable compound present in the third curable composition);

(c4) 0 to 10 wt % of radical initiator; and

(d4) 0 to 55 wt % of solvent.

The amount of each of component (a1), (a2) and (a4) independently is preferably 0 to 40 wt %.

The amount of component (a3) is preferably 0 to 30 wt %, especially 0 to 20 wt %.

The amount of each of components (b1), (b2) and (b4) independently is preferably 5 to 80wt %, especially 10 to 70 wt %.

The amount of component (b3) is preferably 9 to 65 wt %, especially 14 to 59 wt %, more especially 19 to 49 wt %.

The curable compositions which may be used to make the first, second, third and fourth polymers preferably comprise a radical initiator (component (c1), (c2), (c3) and (c4)) when it is intended to cure the composition by UV, visible light or thermally. Alternative methods for curing include electron beam and gamma irradiation. Those methods do not require a radical initiator. Thus the amount of component (c1), (c2), (c3) and (c4) present in the relevant compositions is preferably 0 to 2 wt %, more preferably—for curing by UV, visible light or thermally—0.001 to 2 wt %, especially 0.005 to 0.9 wt %.

The amount of component (dl), (d2) and (d4) present in the relevant compositions is preferably 20 to 45 wt %.

Preferably the solvent(s) used as component (d1), (d2) and (d3) are inert, i.e. they do not react with any of the other components of the curable composition.

The amount of component (d3) is preferably 30 to 90 wt %, especially 40 to 85 wt %, more especially 49 to 78 wt %.

Component (d3) is preferably a single solvent.

Component (d3) optionally comprises two or more inert solvents, at least one of which is a solvent for the other components of the curable composition and at least one of which is a non-solvent for the third polymer formed from curing the composition, e.g. by phase separation, thereby forming the third polymer comprising a network of pores capable of receiving the fourth curable composition.

Examples of inert solvents which may be present in the curable compositions include water, alcohol-based solvents, ether-based solvents, amide-based solvents, ketone-based solvents, sulfoxide-based solvents, sulfone-based solvents, nitrile-based solvents and organic phosphorus-based solvents. Examples of alcohol-based solvents which may be used as or in component (d3) (especially in combination with water) include methanol, ethanol, isopropanol, n-butanol, ethylene glycol, propylene glycol, diethylene glycol, dipropylene glycol and mixtures comprising two or more thereof. Preferably component (d3) is water.

In addition, preferred inert, organic solvents which may be used in component (d3) include dimethyl sulfoxide, dimethyl imidazolidinone, sulfolane, N-methyl pyrrolidone, dimethyl formamide, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate, y-butyrolactone and mixtures comprising two or more thereof. Dimethyl sulfoxide, N-methyl pyrrolidone, dimethyl formamide, dimethyl imidazolidinone, sulfolane, acetone, cyclopentylmethylether, methylethylketone, acetonitrile, tetrahydrofuran, 2-methyltetrahydrofuran and mixtures comprising two or more thereof are preferable.

In one embodiment component (d3) comprises at least one of the solvents from list (i) below and at least one of the solvents from list (ii) below wherein the at least two solvents are different:
list (i): iso-propanol, methanol, ethanol, acetone, tetramethyl urea, hexamethyl phosphoramide, hexamethyl phosphorotriamide, butanone, cyclohexanone, methylethylketone, tetrahydrofuran, tetrahydropyran, 2-methyltetrahydrofuran, cyclopentylmethylether, propionitrile, acetonitrile, 1,4-dioxane, 1,3-dioxolane, ethyl acetate, y-butyrolactone; and
list (ii): water, glycerol, ethylene glycol, dimethyl sulfoxide, sulpholane, dimethyl imidazolidinone, sulfolane, N-methyl pyrrolidone, N,N-dimethyl formamide, N-methyl morpholine, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate and y-butyrolactone.

The choice of solvents depends on the other components of the composition.

In one embodiment component (d3) comprises water and one or more other solvents from list (i).

Preferably one of the first curable composition and the second curable composition comprises a curable compound having an ethylenically unsaturated group and an anionic group and the other comprises a curable compound having an ethylenically unsaturated group and a cationic group. Furthermore, preferably one of the third curable composition and the fourth curable composition comprises a curable compound having an ethylenically unsaturated group and an anionic group and the other comprises a curable compound having an ethylenically unsaturated group and a cationic group. Examples of curable compounds having an ethylenically unsaturated group and an anionic group or cationic group include the following compounds of Formula (A), (B), (CL), (SM), (MA), (MB-a), (C), (ACL-A), (ACL-B), (ACL-C), and/or (AM-B):

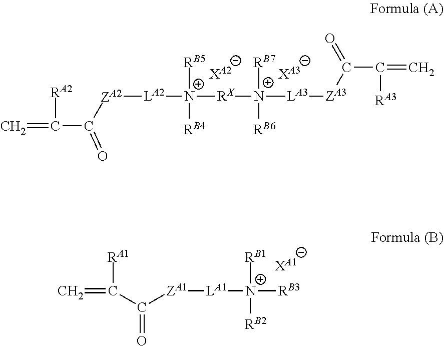

wherein in Formulae (A) and (B),
R^{A1} to R^{A3} each independently represent a hydrogen atom or an alkyl group; R^{B1} to R^{B7} each independently represent an alkyl group or an aryl group;
Z^{A1} to Z^{A3} each independently represent —O— or —NRa—, wherein Ra represents a hydrogen atom or an alkyl group;
L^{A1} to L^{A3} each independently represent an alkylene group, an arylene group or a divalent linking group of a combination thereof;
R^{X} represents an alkylene group, an alkenylene group, an alkynylene group, an arylene group, or a divalent linking group of a combination thereof; and
X^{A1} to X^{A3} each independently represent an organic or inorganic anion, preferably a halogen ion or an aliphatic or aromatic carboxylic acid ion.
Examples of compounds of Formula (A) or (B) include:

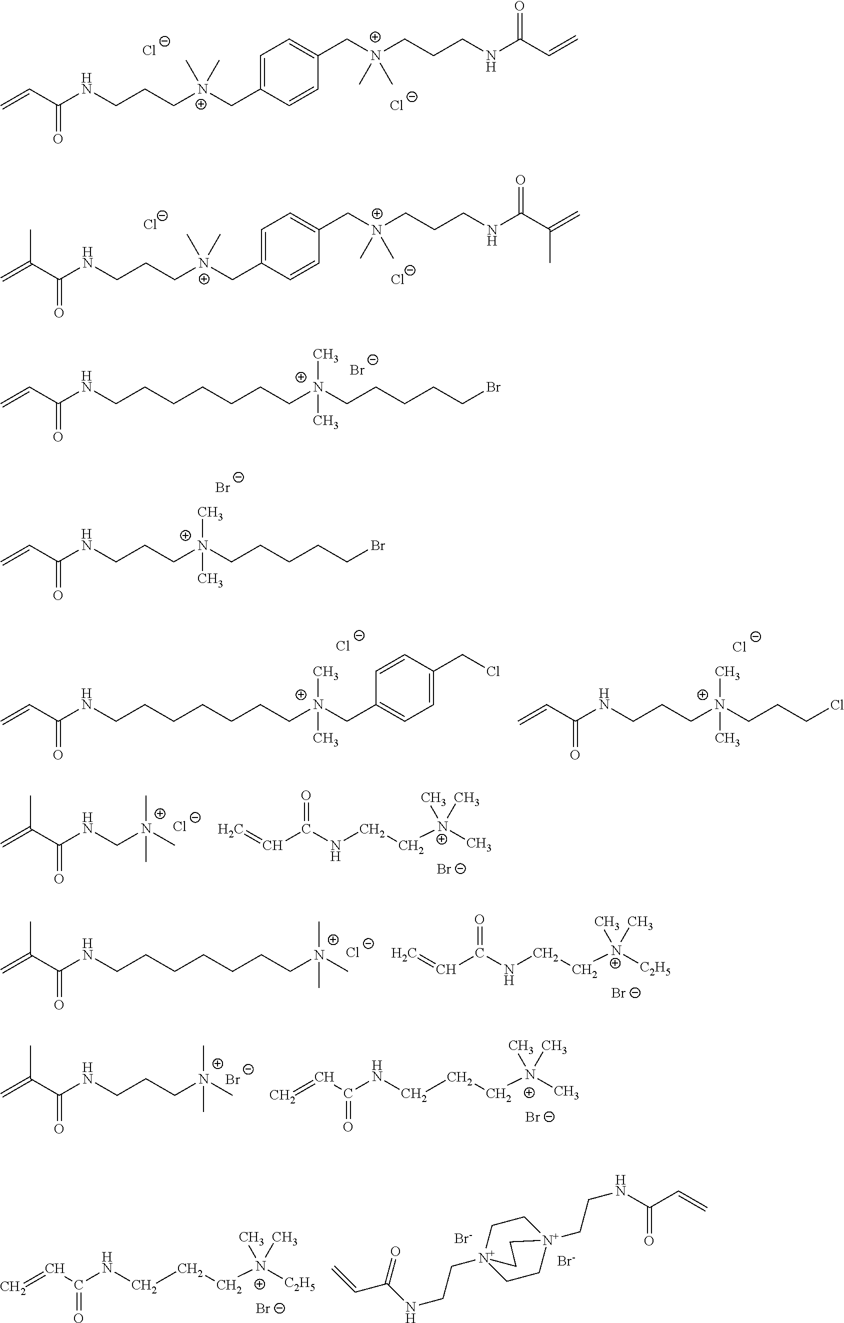

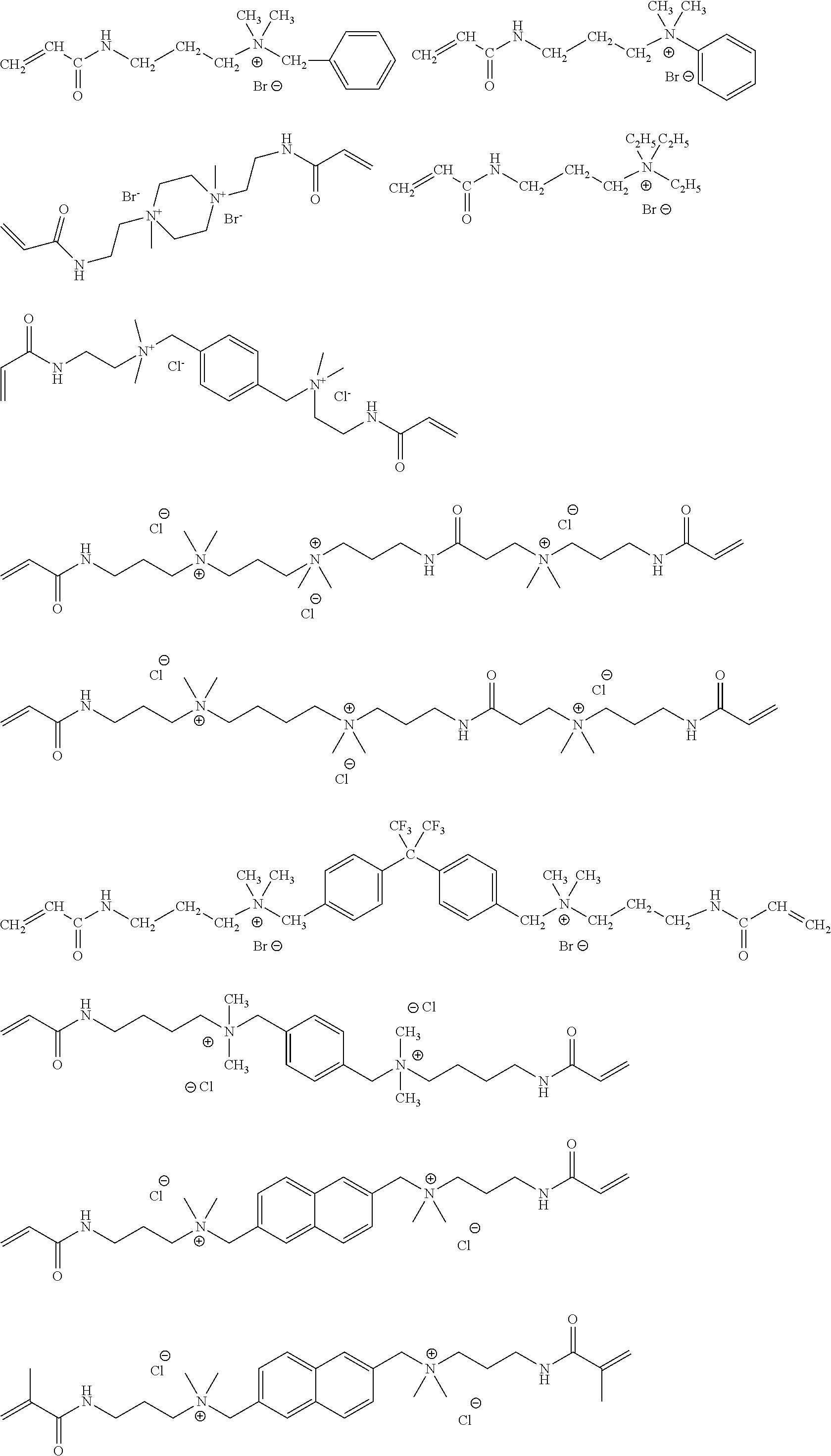

Synthesis methods can be found in e.g. US2015/0353721, US2016/0367980 and US2014/0378561.

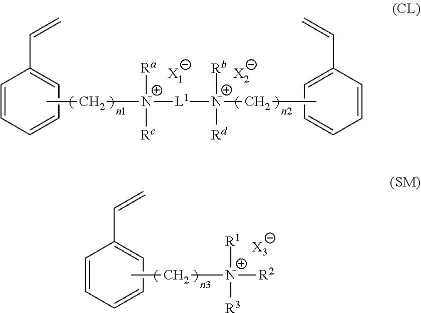

wherein in Formulae (CL) and (SM):
L¹ represents an alkylene group or an alkenylene group;
R^{a}, R^{b}, R^{c}, and R^{d} each independently represent a linear or branched alkyl group or an aryl group,
R^{a} and R^{b}, and/or R^{c} and R^{d} may form a ring by being bonded to each other;
R¹, R², and R³ each independently represent a linear or branched alkyl group or an aryl group, R¹ and R², or R¹, R² and R³ may form an aliphatic heterocycle by being bonded to each other;
n1, n2 and n3 each independently represent an integer of 1 to 10; and
X₁_{^{−}}, X₂_{^{−}} and X₃_{^{−}} each independently represent an organic or inorganic anion.
Examples of formula (CL) and (SM) include:

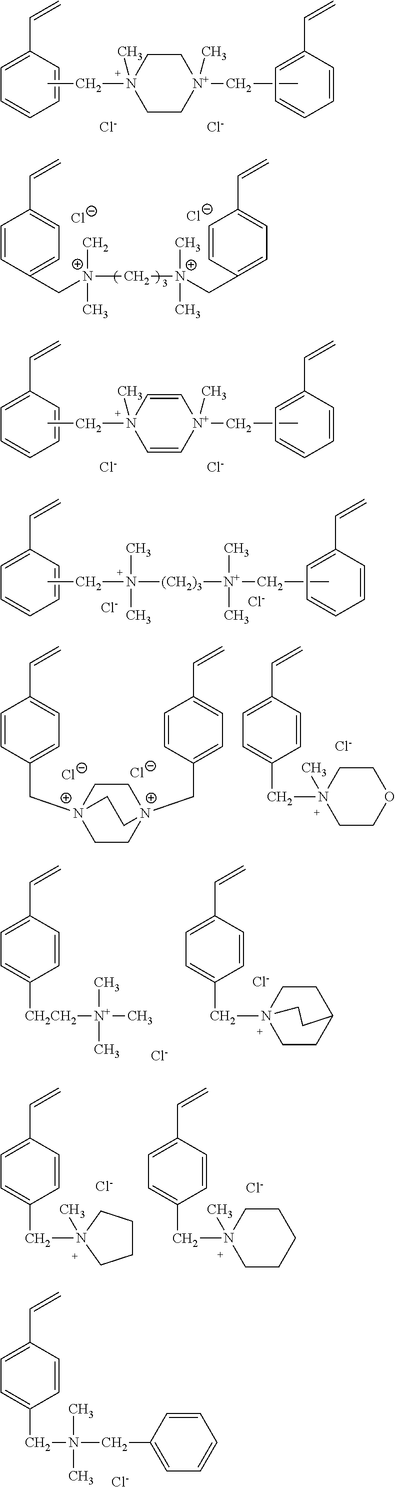

Synthesis methods can be found in EP3184558 and US2016/0001238.

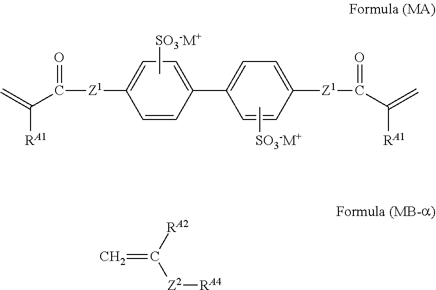

wherein in formula (MA) and (MB-α),
R^{A1} represents a hydrogen atom or an alkyl group;
Z¹ represents —O— or —NRa—, wherein Ra represents a hydrogen atom or an alkyl group;
M⁺ represents an organic or inorganic cation, preferably a hydrogen ion or an alkali metal ion;
R^{A2} represents a hydrogen atom or an alkyl group,
R^{A4} represents an organic group comprising a sulphonic acid group and having no ethylenically unsaturated group; and
Z² represents —NRa—, wherein Ra represents a hydrogen atom or an alkyl group preferably a hydrogen atom.
Examples of formula (MA) and (MB-α) include:

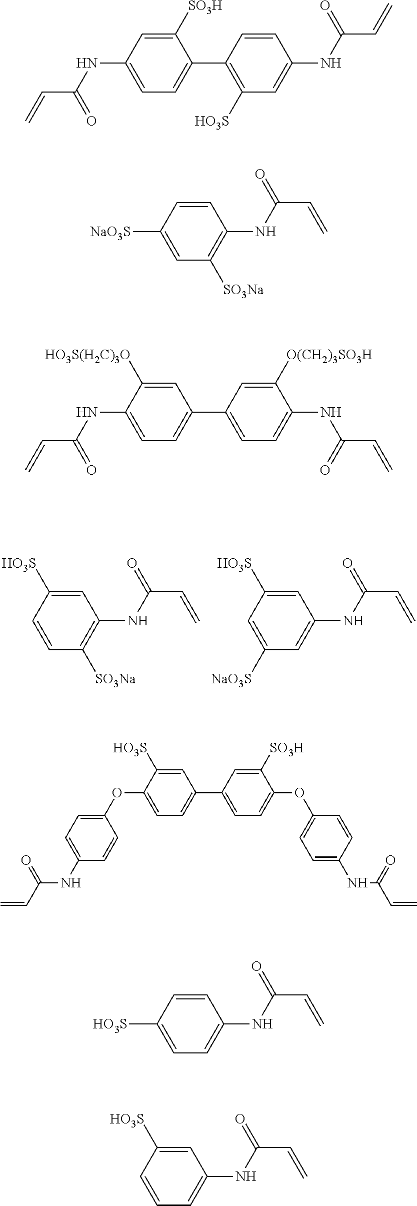

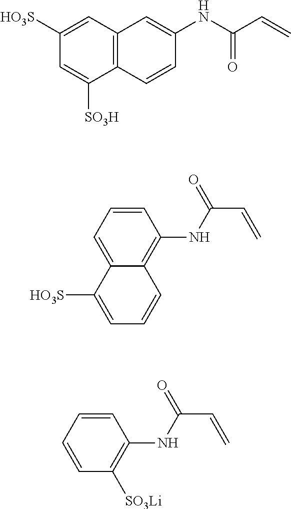

Synthesis methods can be found in e.g. US2015/0353696.

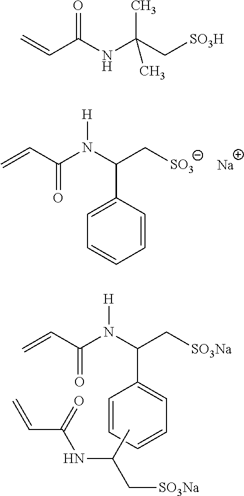

Synthesis methods can be found in e.g. US2016/0369017.

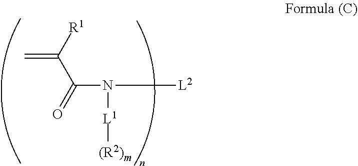

wherein in Formula (C),
L¹ represents an alkylene group;
n represents an integer of 1 to 3, preferably 1 or 2;
m represents an integer of 1 or 2;
L² represents an n-valent linking group;
R¹ represents a hydrogen atom or an alkyl group;
R² represents —SO₃⁻M⁺ or —SO₃R³; in case of plural R²'s, each R² independently represents —SO₃M⁺ or —SO₃R³;
M⁺ represents a hydrogen ion, an inorganic ion, or an organic ion; and
R³ represents an alkyl group or an aryl group.
Examples of formula (C) include:

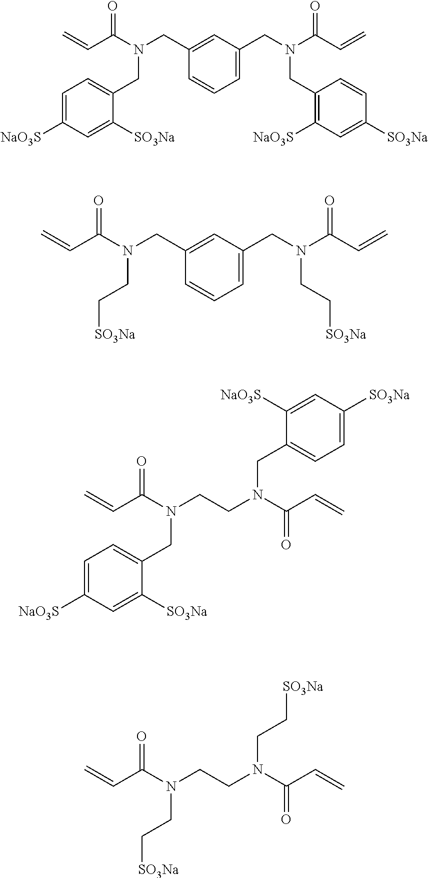

Synthesis methods can be found in EP3187516.

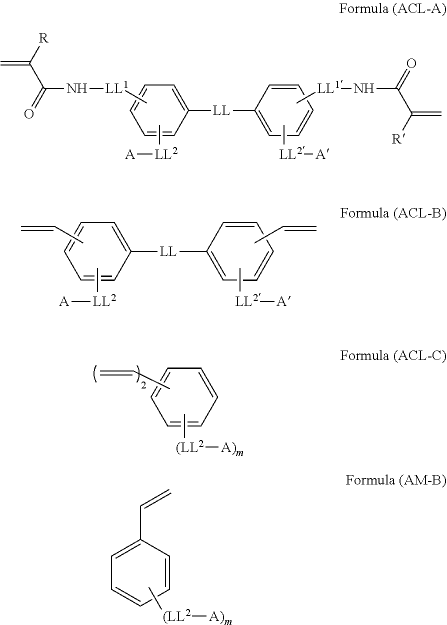

wherein in Formulas (ACL-A), (ACL-B), (ACL-C) and (AM-B),
each of R and R′ independently represents a hydrogen atom or an alkyl group;
LL represents a single bond or a bivalent linking group;
each of LL¹, LL^{1′}, LL², and LL^{2′} independently represents a single bond or a bivalent linking group; and each of A and A′ independently represents a sulfo group in free acid or salt form; and
m represents 1 or 2.
Examples of formula (ACL-A), (ACL-B), (ACL-C) and (AM-B) include:

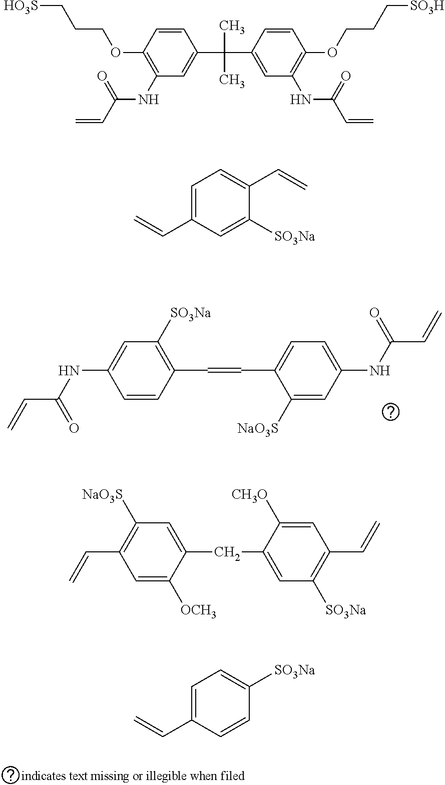

Synthesis methods can be found in US2016/0362526.
Other suitable monomers include:

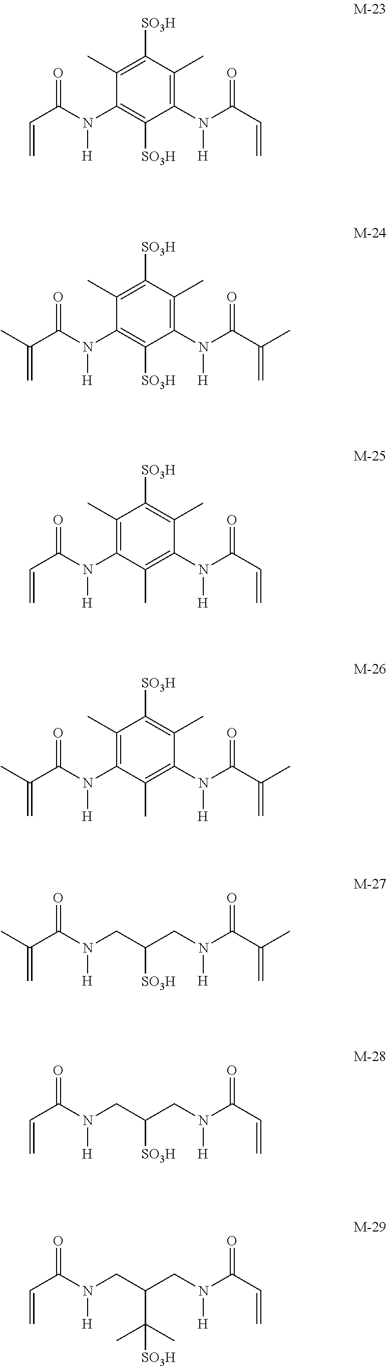

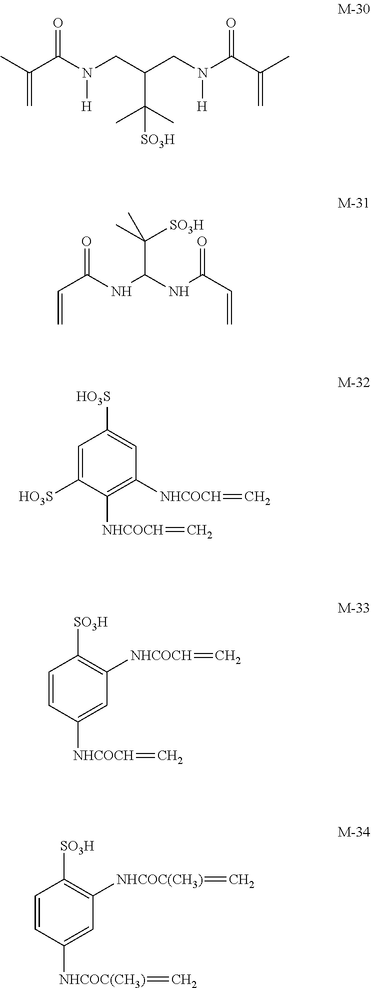

The curable compositions may be cured by any suitable process, including thermal curing, photocuring, electron beam (EB) radiation, gamma radiation, and combinations of the foregoing. However the curable compositions are preferably cured by photocuring, e.g. by irradiating the curable compositions by ultraviolet of visible light and thereby causing the curable components present in the compositions to polymerise.

Examples of suitable thermal initiators which may be included in the curable compositions include 2,2′-azobis(2-methylpropionitrile) (AlBN), 4,4′-azobis(4-cyanovaleric acid), 2,2′-azobis(2,4-dimethyl valeronitrile), 2,2′-azobis(2-methylbutyronitrile), 1,1′-azobis(cyclohexane-1-carbonitrile), 2,2′-azobis(4-methoxy-2,4-dimethyl valeronitrile), dimethyl 2,2′-azobis(2-methylpropionate), 2,2′-azobis[N-(2-propenyl)-2-methylpropionamide, 1-[(1-cyano-1-methylethyl)azo]formamide, 2,2′-Azobis(N-butyl-2-methylpropionamide), 2,2′-Azobis(N-cyclohexyl-2-methylpropionamide), 2,2′-Azobis(2-methylpropionamidine) dihydrochloride, 2,2′-Azobis[2-(2-imidazolin-2-yl)propane]dihydrochloride, 2,2′-Azobis[2-(2-imidazolin-2-yl)propane]disulfate dihydrate, 2,2′-Azobis[N-(2-carboxyethyl)-2-methylpropionamidine]hydrate, 2,2′-Azobis{2-[1-(2-hydroxyethyl)-2-imidazolin-2-yl]propane} dihydrochloride, 2,2′-Azobis[2-(2-imidazolin-2-yl)propane], 2,2′-Azobis(1-imino-1-pyrrolidino-2-ethylpropane) dihydrochloride, 2,2′-Azobis{2-methyl-N-[1,1-bis(hydroxymethyl)-2-hydroxyethl]propionamide} and 2,2′-Azobis[2-methyl-N-(2-hydroxyethyl)propionamide].

Examples of suitable photoinitiators which may be included in the curable compositions include aromatic ketones, acylphosphine compounds, aromatic onium salt compounds, organic peroxides, thio compounds, hexaarylbiimidazole compounds, ketoxime ester compounds, borate compounds, azinium compounds, metallocene compounds, active ester compounds, compounds having a carbon halogen bond, and an alkyl amine compounds. Preferred examples of the aromatic ketones, the acylphosphine oxide compound, and the thio-compound include compounds having a benzophenone skeleton or a thioxanthone skeleton described in “RADIATION CURING IN POLYMER SCIENCE AND TECHNOLOGY”, pp. 77-117 (1993). More preferred examples thereof include an alpha-thiobenzophenone compound described in JP1972-6416B (JP-S47-6416B), a benzoin ether compound described in JP1972-3981B (JP-S47-3981B), an alpha-substituted benzoin compound described in JP1972-22326B (JP-S47-22326B), a benzoin derivative described in JP1972-23664B (JP-S47-23664B), an aroylphosphonic acid ester described in JP1982-30704A (JP-S57-30704A), dialkoxybenzophenone described in JP1985-26483B (JP-S60-26483B), benzoin ethers described in JP1985-26403B (JP-S60-26403B) and JP1987-81345A (JPS62-81345A), alpha-amino benzophenones described in JP1989-34242B (JP H01-34242B), U.S. Pat. No. 4,318,791A, and EP0284561A1, p-di(dimethylaminobenzoyl)benzene described in JP1990-211452A (JP-H02- 211452A), a thio-substituted aromatic ketone described in JP1986-194062A (JPS61-194062A), an acylphosphine sulfide described in JP1990-9597B (JP-H02- 9597B), an acylphosphine described in JP1990-9596B (JP-H02-9596B), thioxanthones described in JP1988-61950B (JP-S63-61950B), and coumarins described in JP1984-42864B (JP-S59-42864B). In addition, the photoinitiators described in JP2008-105379A and JP2009-114290A are also preferable. In addition, photoinitiators described in pp. 65 to 148 of “Ultraviolet Curing System” written by Kato Kiyomi (published by Research Center Co., Ltd., 1989) may be used.

Especially preferred photoinitiators include Norrish Type II photoinitiators having an absorption maximum at a wavelength longer than 380 nm, when measured in one or more of the following solvents at a temperature of 23° C.: water, ethanol and toluene. Examples include a xanthene, flavin, curcumin, porphyrin, anthraquinone, phenoxazine, camphorquinone, phenazine, acridine, phenothiazine, xanthone, thioxanthone, thioxanthene, acridone, flavone, coumarin, fluorenone, quinoline, quinolone, naphtaquinone, quinolinone, arylmethane, azo, benzophenone, carotenoid, cyanine, phtalocyanine, dipyrrin, squarine, stilbene, styryl, triazine or anthocyanin-derived photoinitiator.

The curable compositions may be applied continuously to moving supports, preferably by means of a manufacturing unit comprising curable composition application stations, one or more curing stations comprising irradiation source(s) for curing the compositions, a membrane collecting station and a means for moving the supports from the curable composition application stations to the curing station(s) and to the membrane collecting station.

The curable composition application stations may be located at an upstream position relative to the curing station(s) and the curing station(s) is/are located at an upstream position relative to the membrane collecting station.

Examples of application techniques include slot die coating, slide coating, air knife coating, roller coating, screen-printing, and dipping. Depending on the used technique and the desired end specifications, it might be necessary to remove excess coating from the substrate by, for example, roll-to-roll squeeze, roll-to-blade or blade-to-roll squeeze, blade-to-blade squeeze or removal using coating bars. Curing by ultraviolet of visible light can occur at wavelengths between 100 nm and 800 nm using doses between 40 and 2000 mJ/cm². Thermal curing preferably takes place in the range between 20° C. and 100° C. for 0 to 20 h.

In some cases additional drying might be needed for which temperatures between 40° C. and 200° C. could be employed.

In one embodiment the membrane comprises a catalyst. The catalyst or a precursor thereof may be included in one or more of the first curable composition, the second curable composition, the third curable composition and the fourth composition. Also possible is to apply the catalyst or a precursor thereof (e.g. as a post-treatment step) to the third polymer i.e. after curing the third curable composition) using for example (but not limited to), dipping, air knife coating, microroller coating, spraying, chemical (vapour) deposition or physical (vapour) deposition. In this embodiment the catalyst is present at the (third) interface between the third and the fourth polymer. In a preferred embodiment the third layer comprises a catalyst.

In one embodiment at least one of the layers a), b) and c) and/or interfaces comprises a catalyst.

Examples of suitable catalysts include metal salts, metal oxides, organometallic compounds, monomers, polymers or co-polymers. Examples include, but are not limited to, FeCl₃, FeCl₂, AlCl₃, MgCl₂, RuCl₃, CrCl₃, Fe(OH)₃, Sn(OH)₂, Sn(OH)₄, SnCl₂, SnCl₄, SnO, SnO₂, Al₂O₃, NiO, Zr(HPO₄)₂, MoS₂, graphene oxide, Fe-polyvinyl alcohol complexes, polyvinyl alcohol (PVA), polyethylene glycol (PEG), polyethyleneimine (PEI), polyacrylic acid (PAA), co-polymer of acrylic acid and maleic anhydride (PAAMA) and hyperbranched aliphatic polyester. Any of these catalysts may be present in a range up to 5 wt %, e.g. 0.001 wt % or 1 wt %, of the weight of the membrane.

According to a second aspect of the present invention there is provided a process for preparing a membrane comprising the following steps:
(i) providing a second, third and fourth curable composition and optionally a first curable composition, each such composition comprising a curable compound having an ionic group,
wherein:
a). the ionic group of the curable compound present in the second curable composition has the same polarity as the ionic group of the curable compound present in the third curable composition;
b). the ionic group of the curable compound present in the fourth curable composition has a polarity opposite to the polarity of the ionic group of the curable compound present in the third curable composition; and
c). when the first curable composition is provided, the ionic group of the curable compound present in the first curable composition has a polarity opposite to the polarity of the ionic group of the curable compound present in the third curable composition;
(ii) impregnating a porous support with the third curable composition;
(iii) curing the third curable composition present within the porous support by a process comprising phase separation of a third polymer from the third curable composition, wherein the third polymer comprises ionic groups and a network of pores, thereby providing a base layer comprising the porous support and the third polymer, wherein the base layer comprises a first side and a second side opposite to the first side;
(iv) contacting the first side of the base layer with the fourth curable composition such that at least a part of the fourth curable composition enters into at least a part of the pores of the third polymer and optionally provides a layer of the fourth curable composition on the first side of the base layer;
(v) contacting the second side of the base layer with the second curable composition such that the second curable composition enters into any remaining pores of the third polymer and provides a layer of the second curable composition on the second side of the base layer;
(vi) if contacting the first side of the base layer with the fourth curable composition does not provide a layer of the fourth curable composition on the first side of the base layer, contacting the first side of the base layer with the first curable composition such that a layer of the first curable composition is provided on the first side of the base layer; and
(vii) curing the layers of curable composition present on each side of the base layer and present within the pores of the third polymer in any order or simultaneously to form:
a first layer a) comprising a first polymer or a fourth polymer, in each case having ionic groups of polarity opposite to the polarity of the ionic groups of the third polymer,
a second layer b) comprising a second polymer having ionic groups of the same polarity as the polarity of the ionic groups of the third polymer, and
a third layer c) comprising a co-continuous polymeric network of (i) the third polymer having ionic groups; and (ii) the fourth polymer having ionic groups of polarity opposite to the polarity of the ionic groups of the third polymer and being present within the network of pores of the third polymer;
wherein layer c) is interposed between layer a) and layer b).

In one embodiment of the process, in step (i) the first curable composition is not provided and in step (vi) contacting the first side of the base layer with the fourth curable composition provides a layer of the fourth curable composition on the first side of the base layer (thus it is not necessary to contact the first side of the base layer with a first curable composition such that a layer of the first curable composition is provided on the first side of the base layer because the fourth curable composition provides the first layer a) in addition to the fourth polymer present in layer c)).

In another embodiment in step (iv) a layer of the fourth curable composition is provided on the first side of the base layer and in step (vi) this layer is contacted with the first curable composition such that a layer of the first curable composition is provided on the layer of fourth curable composition present on the first side of the base layer. The other steps are as described above.

The process of the second aspect of the present invention preferably provides a membrane according to the first aspect of the present invention.

In another preferred embodiment one of the first layer a) and the second layer b) comprises a porous support. This may be achieved by including a porous support in the first curable composition or second curable composition during the above process.

In a preferred embodiment the first curable composition and the fourth curable composition each comprise a curable compound having an anionic group and both the second curable composition and the third curable composition comprise a curable compound having a cationic group.

In yet another preferred embodiment, step (ii) of the process further comprises placing the porous support impregnated with the third curable composition between transparent foils to give a sandwich of the impregnated porous support and two foils and then squeezing the sandwich, e.g. between rollers or blades, to remove any excess of third curable composition. After curing step (iii) the transparent foils may be removed before performing step (iv). In a further preferred embodiment curing of the third curable composition in step (iii) is performed under an inert atmosphere, e.g. under nitrogen, carbon dioxide or argon gas.

The membranes of the present invention may be used for various applications, including electrodialysis and acid/base production. The present membranes may also be applied as bipolar membranes, particularly as they have good durability in acidic and basic media, low swelling, and may be produced cheaply, quickly and efficiently.

The invention will now be illustrated by the following, non-limiting examples in which all parts and percentages are by weight unless specified otherwise.

### EXAMPLES

TABLE 1
Ingredients

| Abbreviation | Component Type | Description |
|---|---|---|
| MM-M | Curable compound | Benzenesulphonamide, 4-ethenyl-N- |
| | having an anionic | (methylsulphonyl)-, lithium salt |
| | group (a1) | |
| XL-D | Curable compound | Benzenesulphonamide, 2,4-diethenyl- |
| | having an anionic | N-(methylsulphonyl)-, lithium salt |
| | group (b4) | |
| XL-2 | Curable compound | 1,3-[N- |
| | having an anionic | (ethenylphenylsulphonyl)benzene |
| | group (b1) | sulphonamide], dilithium salt |
| 4OH- | inhibitor | 4-hydroxy-2,2,6,6- |
| TEMPO | | tetramethylpiperidin-1-oxyl, a |
| | | polymerization inhibitor from Sigma- |
| | | Aldrich |
| Omnirad ™ | Initiator (c1/c4) | 2,4,6-Trimethylbenzoyldi- |
| TPO-L | | Phenylphosphinate from IGM Resins |
| MeOH | Inert solvent (d4) | Methanol from Sigma-Aldrich |
| 1MP | Inert solvent (d1) | 1-methyl pyrrole from Sigma-Aldrich |
| water | Inert solvent | Purified water |
| | (d1/d2/d3) | |
| VBTMAC | Curable compound | 4-Vinylbenzyl trimethylammonium |
| | having a cationic | chloride from Sigma-Aldrich |
| | group (a2) | |
| XL-A | Curable compound | N,N,N′,N′- |
| | having a cationic | tetramethyldiaminopropane, 1,4- |
| | group (b2/b3) | bis[(4-ethenylphenyl)methyl]-, |
| | | chloride |
| LAP | Initiator (c1/c3/c4) | Phenyl-2,4,6- |
| | | trimethylbenzoylphosphinate, lithium |
| | | salt from Sigma-Aldrich |
| Irgacure ® | Initiator (c2) | 2-Hydroxy-2-methyl propiophenone |
| 1173 | | from BASF |
| FO-2223- | Porous support | PP/PE porous support of thickness |
| 10C | | 100 μm obtained from Freudenberg |
| | | Filtration Technologies |

Synthesis of XL-A is described in EP29797448 as Synthesis Example 2 on page 21.
XL-D and MM-M may be synthesized as described below.
PP means polypropylene and PE means polyethylene.

TABLE 2
The First, Second, Third and Fourth Curable Compositions

| | First | Second | Third | Fourth |
|---|---|---|---|---|
| | Curable | Curable | Curable | Curable |
| | Composition | Composition | Composition | Composition |
| Component | CC1 (wt %) | CC2(wt %) | CC3 (wt %) | CC4 (wt %) |
| MM-M | 25 | | | |
| VTBMAC | | 23 | | |
| XI-2 | 35 | | | |
| XL-D | | | | 66 |
| XL-A | | 46.1 | 36.4 | |
| 4OH-TEMPO | 1 | 2 | 1 | 1 |
| LAP | 0.5 | | 0.6 | 0.5 |
| Omnirad ™ | 0.5 | | | 0.5 |
| TPO-L | | | | |
| Irgacure ® | | 0.9 | | |
| 1173 | | | | |
| water | 28 | 28 | 62 | |
| MeOH | | | | 32 |
| 1MP | 10 | | | |

### Preparation of Membranes

### Example 1

First, second and third curable compositions were prepared by mixing the components indicated in Table 2. In this Example the first curable composition was also used as fourth curable composition.

A 100 μm thick layer of the third curable composition was applied to a transparent PET foil sheet using a Meyer bar. A porous support (FO2223-10C) was applied to the layer of the third curable composition, thereby becoming impregnated with the third curable composition. A second transparent PET foil sheet was applied to the impregnated porous support to provide a sandwich of the impregnated porous support between the two transparent foils. Gently all air was squeezed out of the porous support using a roller.

The sandwich of the impregnated porous support between the two transparent foils was irradiated using a Light Hammer LH10 from Fusion UV Systems fitted with a D-bulb working at 60% intensity at a speed of 5 m/min in order to cure the third curable composition present in the porous support. After curing, the transparent PET foils were removed and the cured product was allowed to dry in the air at room temperature to give a base layer (i.e. a porous support comprising a third polymer comprising ionic groups and a network of pores) having a first side and a second side.
The base layer was dipped in a catalyst solution comprising 1.35 wt % of tin(II)chloride in a slightly acidic aqueous solution, and allowed to dry at room temperature. Subsequently the base layer was dipped in a 0.12 N NaOH solution to precipitate the catalyst and was allowed to dry at room temperature

The first curable composition was applied to a transparent PET foil using a 80 μm Meyer bar. Then the base layer comprising a catalyst, prepared as described above, was placed on top of the layer of first curable composition with the first side of the base layer contacting the first curable composition whereupon a part of the first composition (which in this case doubles-up as fourth composition) entered into the pores of the third polymer. This gave a base layer impregnated with the first curable composition (which in this case doubles-up as fourth composition) and provided a layer of the first curable composition (which in this case doubles-up as fourth composition) on the first side of the base layer.

The base layer impregnated with the first curable composition and having a layer of the first composition (which in this case doubles-up as fourth composition) on its first side was irradiated on the second side of the base layer (i.e. the side without the first curable composition) using a Light Hammer LH10 from Fusion UV Systems fitted with a D-bulb working at 50% intensity at a speed of 5 m/min. The resulting cured film was a laminate of layer a) and layer c) in which the pores of the third polymer were filled with cured first curable composition.

A 100 μm layer of the second curable composition was applied to the second side of the laminate of layer a) and layer c) which was free from layer a) using a Meyer bar and a second porous support (FO2223-10C) was applied to the layer of the second curable composition. After 5 seconds excess second curable composition was removed using a 4 μm Meyer bar.

The resulting product was irradiated on both sides using a Light Hammer LH10 from Fusion UV Systems fitted with a D-bulb working at 50% intensity at a speed of 5 m/min in order to cure the second curable composition. Finally the PET foil was removed to give a bipolar, composite membrane according to the first aspect of the present invention comprising the first layer a), the second layer b) and the third layer c) interposed between the first layer a) and the second layer b).

### Example 2

First, second, third and fourth curable compositions were prepared by mixing the components indicated in Table 2.

A 60 μm thick layer of the third curable composition was applied to a porous support laying on a transparent PET foil sheet using a Meyer bar. Excess curable composition was removed from the porous support using a 4 μm Meyer bar thereby ensuring that the porous support was impregnated with the third curable composition. A second transparent PET foil sheet was applied to the impregnated porous support to provide a sandwich of the impregnated porous support between the two transparent foils. Gently all air was squeezed out of the porous support using a roller.

The sandwich of the impregnated porous support between the transparent two foils was irradiated using a Light Hammer LH10 from Fusion UV Systems fitted with a D-bulb working at 60% intensity at a speed of 5 m/min in order to cure the third curable composition present in the porous support. After curing, the PET foils were removed and the cured product was allowed to dry in the air at room temperature to give a base layer (i.e. a porous support comprising a third polymer comprising ionic groups and a network of pores) having a first side and a second side.

The base layer was dipped in a catalyst solution comprising 1.35 wt % of tin(II)chloride in a slightly acidic aqueous solution, and allowed to dry at room temperature. Subsequently the base layer was dipped in a 0.12 N NaOH solution to precipitate the catalyst and was allowed to dry at room temperature.

The base layer comprising a catalyst, prepared as described above, was placed with its second side on a transparent PET foil. The fourth curable composition was applied to the first side of the base layer (comprising a catalyst) using a 24 μm Meyer bar, thereby impregnating the porous network of the third polymer with the fourth curable composition. Excess of the fourth curable composition was removed using a 4 μm Meyer bar.

The first curable composition was applied onto another transparent PET foil using a 60 μm Meyer bar. The base layer comprising the third polymer and the fourth curable composition in the porous network of the third polymer was placed on the layer of first curable composition with the first side of the base layer contacting the first curable composition. As a result, a base layer with a fourth curable composition in the network of pores of the third polymer and a layer of the first curable composition on the first side of the base layer was formed.

The base layer with the fourth curable composition present in the pores of the third polymer and a layer of the first curable composition at the first side of the base layer was irradiated on the second side (i.e. the side not carrying the first curable composition) using a Light Hammer LH10 from Fusion UV Systems fitted with a D-bulb working at 50% intensity at a speed of 5 m/min after which the transparent PET foil on the second side of the base layer was removed. The resulting cured film was a laminate of layer a) and layer c) in which the pores of the third polymer were filled with a fourth polymer obtained by curing the fourth curable composition.

The second curable composition was applied to a second porous support (FO2223-10C) using a 60 μm Meyer bar to give an impregnated second porous support. The impregnated second porous support was then applied to the laminate of layer a) and layer c) on the second side of thereof (the side opposite to layer a)). After 5 seconds excess second curable composition was removed using a 4 μm Meyer bar. The resulting product was irradiated on both sides using a Light Hammer LH10 from Fusion UV Systems fitted with a D-bulb working at 50% intensity at a speed of 5 m/min in order to cure the second curable composition. Finally the transparent PET foil was removed to give a bipolar, composite membrane according to the first aspect of the present invention comprising the first layer a), the second layer b) and the third layer c) interposed between the first layer a) and the second layer b).

### Characterization of the Membranes

The volume fraction is the fraction of the volume of the third polymer in the third layer c) (or the volume fraction of the fourth polymer, the latter being identical to the first polymer in Example 1 and different in Example 2). The volume fraction was determined by embedding a sample of Example 1 and 2 respectively in a resin and cutting a thin slice using a microtome. This slice was analysed by an atomic force microscope (AFM) equipped with an infrared probe. Line spectra were obtained across 80 μm, recording an IR spectrum every 3 μm, followed by principle component analysis using characterizing frequencies in the IR spectra. The resultant image showed the third polymer and the fourth polymer as discrete polymers, with the third polymer identified in green and the fourth polymer identified in blue. The third and fourth polymers were seen to be a co-continuous network in the third layer c).

The volume fraction of each of the two polymers (i.e. the relative volume of the third polymer and of the fourth polymer in third layer c)) was estimated by its colour and the fractions are given in Table 3 below.

The electrochemical properties of the membranes from Example 1 and Example 2 and their bipolar characteristics were compared to a commercially available bipolar membrane (BPM) by determining their so called current-voltage characteristic (I-U curves), from which the voltage at a certain current density was derived. This evaluation revealed that the voltage of the bipolar composite membranes of the present invention were lower than that of the commercially available BPM at a current density of 800 A/cm². The results are shown in Table 3 below.

TABLE 3
Electrochemical properties and volume fraction

| | Voltage at | Volume fraction of |
|---|---|---|
| Sample | 800 A/m² (V) | 3^{rd}/4^{th} polymer |
| Commercially available BPM | 0.98 | n.d. |
| Ex. 1 | 0.88 | 0.41/0.54 |
| Ex. 2 | 0.92 | 0.43/0.52 |

n.d. means not determined

### Synthesis of Anionic Monomers and Cross-Linkers and Their Precursors

### CI-SS

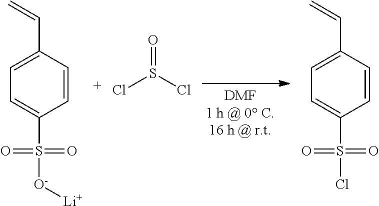 [0202] Thionyl chloride (109 mL, 178.46 g, 1.5 mol, 3 moleq) was added dropwise to a solution of 4-vinylbenzenesulfonic acid lithium salt (95.08 g, 0.500 mol, 1 moleq) and 4OH-TEMPO (50 mg, 500 ppm) in DMF (300 mL) in a double-walled reactor that was actively cooled to 5° C. After the addition was completed, the solution was allowed to slowly heat to room temperature and was stirred for another 16 hours. Then the reaction mixture was poured into 1 liter of cold 1 M KCl in a separation funnel. The bottom layer was removed and dissolved in 500 mL diethylether. This solution was washed with a 1 M KCl-solution (300 mL). The organic layer was dried over sodium sulfate, filtered and concentrated in vacuum to give a yellow oil. The crude product (CL-SS) was used without further purification in the next step. Typical yield is 89.5 g (88%). HPLC-MS purity >98%; ¹H-NMR: <2 wt % DMF, 0% diethyl ether.

### CI-DVBS

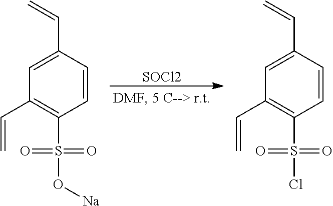 [0204] Thionyl chloride (75 mL, 123.1 g, 1.034 mol, 3 moleq) was added dropwise to an solution of divinylbenzene sulfonate sodium salt (80 g, 0.345 mol, 1 moleq) and 4OH-TEMPO (50 mg, 500 ppm) in DMF (300 mL) in a double-walled reactor that was actively cooled to 5° C. After the addition was completed, the solution was allowed to slowly heat to room temperature and was stirred for another 16 hours. Then the reaction mixture was poured into 1 litre of cold 1 M KCl in a separation funnel. The bottom layer was removed and dissolved in 500 mL diethylether. This solution was washed with a 1 M KCl-solution (300 mL). The organic layer was dried over sodium sulfate, filtered and concentrated in vacuo to give a yellow oil. The crude product (CI-DVBS) was used without further purification in the next step. Typical yield is 62 g (79%). HPLC-MS purity >98%; ¹H-NMR: <2 wt % DMF, 0% diethyl ether.

### NH2-SS

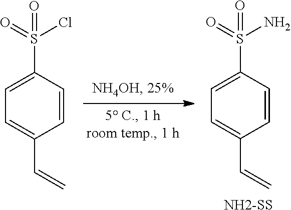 [0206] Thionyl chloride (109 mL, 178.46 g, 1.5 mol, 3 moleq) was added dropwise to a solution of 4-vinylbenzene-sulfonic acid lithium salt (95.08 g, 0.500 mol, 1 moleq) and 4OH-TEMPO (50 mg, 500 ppm) in DMF (300 mL) in a double-walled reactor that was actively cooled to 5° C. After the addition was completed, the solution was allowed to slowly heat to room temperature and was stirred for another 16 hours. Then the reaction mixture was poured into 1 liter of cold 1 M KCl in a separation funnel. The bottom layer was removed and was added dropwise to a solution of ammonium hydroxide 25% in water (250 mL, 3.67 mol, 15 moleq) and 4OH-TEMPO (50 mg, 500 ppm) in a double-walled reactor that was actively cooled to 5° C. After the addition was completed, the solution was stirred for 1 hour. The solution was then allowed to heat to room temperature and was stirred for one hour. Then the reaction mixture was cooled back to 5° C. and the product was filtered off and washed with 50 mL of cold water. The product (NH2-SS) was dried overnight in vacuum at 30° C. and used without further purification. Typical yield is 66.8 g (73%). HPLC-MS purity >95%.

### Synthesis of XL-D

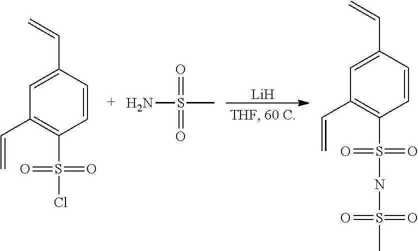 [0208] Before the synthesis, methane sulfonamide was dried in a vacuum oven overnight (30° C., vac). To a solution of the dried methane sulfonamide (8.32 g, 0.087 mol, 1 moleq) and 4OH-TEMPO (30 mg, 500 ppm) in THF (100 mL) was added LiH (1.53 g, 0.192 mol, 2.2 moleq) as a solid at once. The reaction mixture was stirred for 30 minutes at room temperature. Then, a solution of CI-DVBS (20 g, 0.087 mol, 1 moleq) in THF (50 mL) was added to the reaction mixture. After addition, the reaction mixture was heated to 60° C. (water bath temperature). After two days, the reaction mixture was filtrated over celite to remove the excess of LiH. The filtrate was concentrated in vacuo to give a light yellow foam. The resulting foam was dissolved in 500 mL ethyl acetate. Celite was added and the resulting slurry was stirred for 5 minutes. Then, the celite was filtered off and washed with 100 mL ethyl acetate. This Celite procedure was then repeated. The solvent was then evaporated in vacuo and the resulting white foam was washed with 500 mL diethyl ether overnight. The resulting white powder was filtered off and dried in a vacuum oven at 30° C. for 16h yielding a hygroscopic white solid. Typical achieved yield is 15.5 g (60%). HPLC-MS purity >95%; ¹H-NMR: <3 wt % residual solvents; 2 wt % divinylbenzene sulfonate; ICP-OES: 24-30 g Li/kg product.

### Synthesis of XL-2

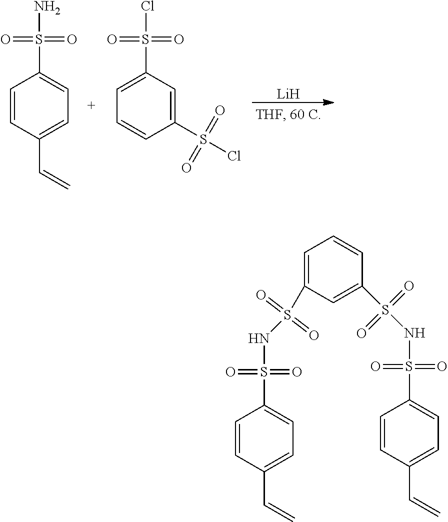

Before the synthesis, styrene sulfonamide (NH2-SS) was dried in a vacuum oven overnight (30° C., vac). To a solution of the dried styrene sulfonamide (16.90 g, 0.092 mol, 2.05 moleq) and 4OH-TEMPO (30 mg, 500 ppm) in THF (100 mL) was added LiH (1.50 g, 0.189 mol, 4.2 moleq) as a solid at once. The reaction mixture was stirred for 30 minutes at room temperature. Then, a solution of 1,3 benzene disulfonyl chloride (12.38 g, 0.045 mol, 1 moleq) in THF (50 mL) was added to the reaction mixture. After addition, the reaction mixture was heated to 60° C. (water bath temperature). After 2 days, the reaction mixture was filtrated over celite to remove the excess of LiH. The filtrate was concentrated in vacuo to give a light yellow foam. The resulting foam was dissolved in 500 mL ethyl acetate. Celite was added and the resulting slurry was stirred for 5 minutes. Then, the celite was filtered off and washed with 100 mL ethyl acetate. This Celite procedure was then repeated. The solvent was then evaporated in vacuo and the resulting white foam was washed with 500 mL diethyl ether overnight. The resulting white powder was filtered off and dried in a vacuum oven at 30° C. for 16 h yielding a hygroscopic white solid. Typical achieved yield is 14.5 g (54%). HPLC-MS purity >96%; ¹H-NMR: <2 wt % residual solvents; <2 wt % styrene sulfonamide; ICP-OES: 35-40 g Li/kg product.

### Synthesis of MM-M

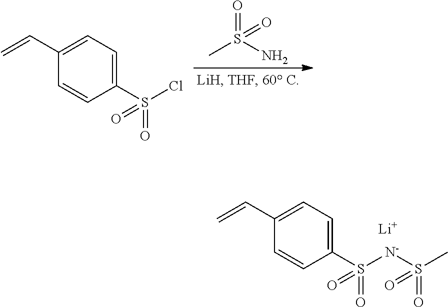 [0212] Before the synthesis, methane sulfonamide was dried in a vacuum oven overnight at 30° C. To a solution of the dried methane sulfonamide (0.100 mol, 1 moleq) and 4OH-TEMPO (30 mg, 500 ppm) in THF (100 mL) was added LiH (0.300 mol, 3 moleq) as a solid at once. The reaction mixture was stirred for 30 minutes at room temperature. Then, a solution of vinyl benzyl sulphonyl chloride (CI-SS) (0.100 mol, 1 moleq) in THF (50 mL) was added and the reaction mixture was heated to 60° C. (water bath temperature) for 16 h. The resulting solution was filtrated over celite and the resulting foam was dissolved in 500 mL ethyl acetate. Celite was added and the resulting slurry was stirred for 5 minutes. Then, the celite was filtered off and washed 30 with 100 mL ethyl acetate. The solvent was then evaporated in vacuum and the resulting white foam was crushed with 500 mL diethyl ether overnight. The resultant product was collected by filtration and isolated as a white hygroscopic powder (yield was 80%, purity >94%).

1. A membrane comprising:
a) a first layer comprising a first polymer or a fourth polymer having ionic groups of polarity opposite to the polarity of the ionic groups of the third polymer;
b) a second layer comprising a second polymer having ionic groups of polarity the same as the polarity of the ionic groups of the third polymer; and
c) a third layer comprising a co-continuous polymeric network of (i) a third polymer having ionic groups and a network of pores; and (ii) a fourth polymer having ionic groups of polarity opposite to the polarity of the ionic groups of the third polymer;
wherein third layer c) is interposed between first layer a) and second layer b) and the third polymer is obtainable by a process comprising phase separation of the third polymer from a curable composition used to prepare the third polymer.

2. The membrane according to claim 1 wherein the third layer comprises an interface at the junction of the third polymer and the fourth polymer which is not an interface between a polymer and fused/compressed fibers, beads, or particles.

3. The membrane according to claim 1 wherein the polymerisation induced phase separation comprises photopolymerization-induced phase separation.

4. The membrane according to claim 1 wherein the co-continuous polymeric network comprises the third polymer and the fourth polymer, wherein the third polymer provides a network of pores and the fourth polymer is present within that network of pores.

5. The membrane according to claim 1 wherein at least the third layer c) comprises a porous support.

6. The membrane according to claim 1 wherein the third layer c) is free from ionically charged fibres and beads.

7. (canceled)

8. The membrane according to claim 1 wherein the third polymer provides a network of pores and the third layer c) is obtained by a process comprising impregnating the network of pores with a composition used to make the fourth polymer and curing the fourth curable composition within the network of pores of the third polymer.

9. The membrane according to claim 1 wherein the chemical composition of the first polymer is substantially the same as the chemical composition of the fourth polymer.

10-16. (canceled)

17. The membrane according to claim 1 which comprises a first interface at the junction of the first layer a) and the third layer c) and a second interface at the junction of the third layer c) and the second layer b) and both the first interface and the second interface are uninterrupted, without any gaps and/or spaces between the first layer a) and the third layer c) and without any gaps and/or spaces between the third layer c) and the second layer b).

18. The membrane according to claim 1 which comprises a third interface at the junction of the third polymer and the fourth polymer which is uninterrupted, without any gaps and/or spaces between the third polymer and the fourth polymer.

19. (canceled)

20. The membrane according to claim 1 wherein each of the first and the fourth polymer independently is obtainable by a process comprising curing a composition comprising:
(a1) 0 to 60 wt % of a curable compound having one ethylenically unsaturated group and an ionic group;
(b1) 1 to 88 wt % of a curable compound comprising at least two ethylenically unsaturated groups and an ionic group;
(c1) 0 to 10 wt % of radical initiator; and
(d1) 0 to 55 wt % of solvent.

21. The membrane according to claim 1 wherein the second polymer is obtainable by a process comprising curing a composition comprising:
(a2) 0 to 60 wt % of a curable compound having one ethylenically unsaturated group and an ionic group;
(b2) 1 to 88 wt % of a curable compound comprising at least two ethylenically unsaturated groups and an ionic group;
(c2) 0 to 10 wt % of radical initiator; and
(d2) 0 to 55 wt % of solvent.

22. The membrane according to claim 1 wherein the third polymer is obtainable by a process comprising curing a composition comprising:
(a3) 0 to 60 wt % of curable compound having one ethylenically unsaturated group and an ionic group;
(b3) 1 to 70 wt % of a curable compound comprising at least two ethylenically unsaturated groups and an ionic group;
(c3) 0 to 10 wt % of radical initiator; and
(d3) 20 to 98 wt % of solvent.

23. The membrane according to claim 1 which is a bipolar membrane.

24. The membrane according to claim 1 wherein the volume fraction of the third polymer in the third layer is from 0.1 to 0.9.

25. The membrane according to claim 1 wherein at least one of the layers and/or interfaces comprises a catalyst.

26. The membrane according to claim 1 wherein the first polymer and the fourth polymer comprise anionic groups and the second and the third polymer comprise cationic groups.

27. A process for preparing a membrane comprising the following steps:
(i) providing a second, third and fourth curable composition and optionally a first curable composition, each such composition comprising a curable compound having an ionic group, wherein:
a). the ionic group of the curable compound present in the second curable composition has the same polarity as the ionic group of the curable compound present in the third curable composition;
b). the ionic group of the curable compound present in the fourth curable composition has a polarity opposite to the polarity of the ionic group of the curable compound present in the third curable composition; and
c). when the first curable composition is provided, the ionic group of the curable compound present in the first curable composition has a polarity opposite to the polarity of the ionic group of the curable compound present in the third curable composition;
(ii) impregnating a porous support with the third curable composition;
(iii) curing the third curable composition present within the porous support by a process comprising phase separation of a third polymer from the third curable composition, wherein the third polymer comprises ionic groups and a network of pores, thereby providing a base layer comprising the porous support and the third polymer, wherein the base layer comprises a first side and a second side opposite to the first side;
(iv) contacting the first side of the base layer with the fourth curable composition such that at least a part of the fourth curable composition enters into at least a part of the pores of the third polymer and optionally provides a layer of the fourth curable composition on the first side of the base layer;
(v) contacting the second side of the base layer with the second curable composition such that the second curable composition enters into any remaining pores of the third polymer and provides a layer of the second curable composition on the second side of the base layer;
(vi) if contacting the first side of the base layer with the fourth curable composition does not provide a layer of the fourth curable composition on the first side of the base layer, contacting the first side of the base layer with the first curable composition such that a layer of the first curable composition is provided on the first side of the base layer; and
(vii) curing the layers of curable composition present on each side of the base layer and present within the pores of the third polymer in any order or simultaneously to form:
a first layer a) comprising a first polymer or a fourth polymer, in each case having ionic groups of polarity opposite to the polarity of the ionic groups of the third polymer,
a second layer b) comprising a second polymer having ionic groups of the same polarity as the polarity of the ionic groups of the third polymer, and
a third layer c) comprising a co-continuous polymeric network of (i) the third polymer having ionic groups; and (ii) a fourth polymer having ionic groups of polarity opposite to the polarity of the ionic groups of the third polymer and being present within the network of pores of the third polymer;
wherein third layer c) is interposed between first layer a) and second layer b).

28. The process according to claim 27 wherein in step (i) the first curable composition is not provided and in step (vi) contacting the first side of the base layer with the fourth curable composition provides a layer of the fourth curable composition on the first side of the base layer.

29. The process according to claim 27 wherein the membrane comprises
a) a first layer comprising a first polymer or a fourth polymer having ionic groups of polarity opposite to the polarity of the ionic groups of the third polymer;
b) a second layer comprising a second polymer having ionic groups of polarity the same as the polarity of the ionic groups of the third polymer; and
c) a third layer comprising a co-continuous polymeric network of (i) a third polymer having ionic groups and a network of pores; and (ii) a fourth polymer having ionic groups of polarity opposite to the polarity of the ionic groups of the third polymer;
wherein third layer c) is interposed between first layer a) and second layer b) and the third polymer is obtainable by a process comprising phase separation of the third polymer from a curable composition used to prepare the third polymer.

30. The process according to claim 27 wherein the first curable composition and the fourth curable composition each comprise a curable compound having an anionic group and both the second curable composition and the third curable composition comprise a curable compound having a cationic group.

31. The process according to claim 27 wherein step (ii) further comprises placing the porous support impregnated with the third composition between transparent foils to give a sandwich of the impregnated porous support and two foils and then squeezing the sandwich to remove any excess of third curable composition.

32. The process according to claim 27 wherein after curing step (iii) the transparent foils are removed before performing step (iv).

33. The process according to claim 27 wherein curing of the third curable composition in step (iii) is performed under an inert atmosphere.
